(19) United States
(12) Patent Application Publication
(10) Pub. No.: US 2026/0072130 A1
(43) Pub. Date: Mar. 12, 2026

(54) System and method for detecting and mitigating unauthorized access from malicious scanning devices

(71) Applicant: Bank of America Corporation, Charlotte, NC (US)

(72) Inventors: Adam King, Fort Mill, SC (US); Coreen Marks, North Myrtle Beach, SC (US); Karishma Batra, Flintshire (GB); James Edward Bowden, Cheshire (GB); Camilla Solideo, Chicago, IL (US); Racquel Butler, Pineville, NC (US)

(21) Appl. No.: 18/828,075

(22) Filed: Sep. 9, 2024

(51) Int. Cl. G01S 7/38; G01S 13/88

(52) U.S. Cl. CPC G01S 7/38; G01S 13/88

(57) ABSTRACT

A portable device for detecting and mitigating skimming/malicious devices that attempt to gain access to information associated with the portable device is disclosed. The portable device detects the first electromagnetic signal associated with an external device and determines the first set of attributes associated with the first electromagnetic signal. The portable device compares the first electromagnetic signal with an expected electromagnetic signal by comparing each attribute from among the first set of attributes with a corresponding attribute associated with the expected electromagnetic signal. The portable device determines a difference between the first electromagnetic signal and the expected electromagnetic signal based on the comparison. If the determined difference is more than a threshold value, the portable device performs one or more countermeasure actions including an emission of the particular electromagnetic signal via the electromagnetic signal emitter.

### TECHNICAL FIELD

The present disclosure relates generally to network security, and more specifically to a system and method for detecting and mitigating unauthorized access from malicious scanning devices.

### BACKGROUND

Portable devices are used to communicate with other devices. For example, a portable device may be used to communicate data with another device using a near-field communication protocol.

### SUMMARY

The disclosed system, described in the present disclosure, is particularly integrated into a practical application of improving the unauthorized access attempt detection and mitigation techniques with respect to unauthorized attempts to remotely access portable devices.

In the current systems, malicious devices (such as malicious scanning devices) pose a significant threat to people and organizations, leading to unauthorized access to sensitive information and compromised sensitive information associated with people and organizations. Existing security measures are insufficient in detecting and neutralizing skimming devices, necessitating the development of more robust solutions to protect against skimming devices. Bad actors may install a skimming device at a particular location where users typically use their portable devices. For example, a skimming device may be installed within, above, or underneath a kiosk, a legitimate scanning device, or a station, among others. If such skimming devices are left undetected, they may scan and access information associated with portable devices, for example, when the portable devices are used to communicate with legitimate devices.

The disclosed system provides a solution to these and other technical problems arising in the realm of information security and network security. The disclosed system addresses the challenge of device skimming by equipping portable devices with technology capable of detecting and mitigating unauthorized skimming devices. When a skimming device is detected, the system triggers a mechanism within the portable device to mitigate the skimming device, preventing further unauthorized access to data available at the portable device. Additionally, the disclosed system includes an alerting mechanism to notify the host machine and relevant authorities of the presence and location of the skimming device, facilitating rapid response and mitigation efforts.

In some embodiments, the disclosed system is configured to detect a presence of a skimming device based on a deviation in electromagnetic signals caused by the skimming device. The electromagnetic field sensor circuit associated with the portable device may detect deviations in electromagnetic signals within its detection range. In some embodiments, the disclosed system is configured to perform one or more countermeasure actions to mitigate the skimming device. In some examples, the countermeasure actions may include emitting a short-range electromagnetic signal directed toward the skimming device, altering magnetic properties of the magnetic stripe of the portable device, deploying a retractable shield to cover at least a portion of the surface of the portable device, project/spray an adhesive substance toward the skimming device, communicate notification alerts to the user and authorities indicating the location of the skimming device and the detected attempt to scan/access the portable device, implementing security measures, including cryptographic protocols, authentication mechanisms, and tamper-resistant enclosure, anti-reply mechanism, among others. In this way, the disclosed system improves the unauthorized access attempt detection and mitigation techniques via skimming devices.

In some embodiments, a system comprises a processor operably coupled with a memory, an electromagnetic field sensor circuit, and an electromagnetic signal emitter circuit. The memory is configured to store an indication of an expected electromagnetic signal associated with at least one operation experienced by a portable device. The electromagnetic field sensor circuit is configured to detect electromagnetic signals. The electromagnetic signal emitter circuit is configured to emit a particular electromagnetic signal. The processor is configured to detect, via the electromagnetic field sensor circuit, a first electromagnetic signal, wherein the first electromagnetic signal originates from an external device. The processor is further configured to determine a first set of attributes associated with the first electromagnetic signal, wherein the first set of attributes comprises a first power level, a first frequency range, and a first electromagnetic pattern associated with the first electromagnetic signal. The processor is further configured to compare the first electromagnetic signal with the expected electromagnetic signal, wherein comparing the first electromagnetic signal with the expected electromagnetic signal comprises comparing at least one attribute from among the first set of attributes with a corresponding attribute associated with the expected electromagnetic signal. The corresponding attribute comprises a second power level, a second frequency range, or a second electromagnetic pattern. The processor is further configured to determine, based at least in part upon the comparison, a difference between the first electromagnetic signal and the expected electromagnetic signal. The processor is further configured to determine that the difference between the first electromagnetic signal and the expected electromagnetic signal is more than a threshold value. The processor is further configured to determine that the external device is a malicious device attempting to access information associated with the portable device in response to determining that the difference between the first electromagnetic signal and the expected electromagnetic signal is more than the threshold value. The processor is further configured to perform one or more countermeasure actions, wherein the one or more countermeasure actions comprise an emission of the particular electromagnetic signal via the electromagnetic signal emitter circuit, wherein the particular electromagnetic signal is configured to counter an electromagnetic field generated by the external device.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system for detecting and mitigating skimming devices; and

FIG. 2 illustrates an example flow chart of a method of the system of FIG. 1.

### DETAILED DESCRIPTION

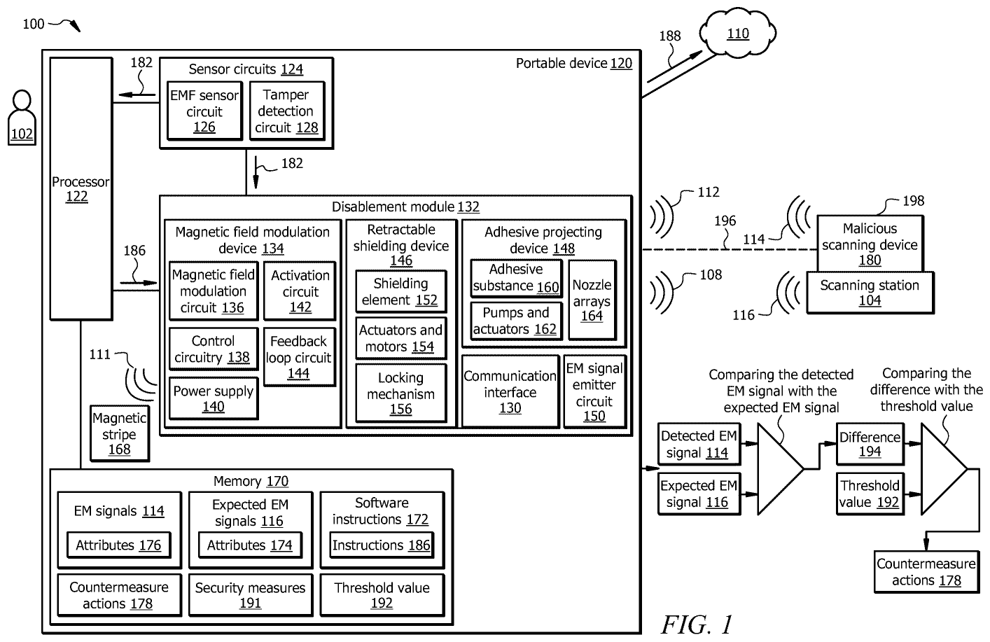

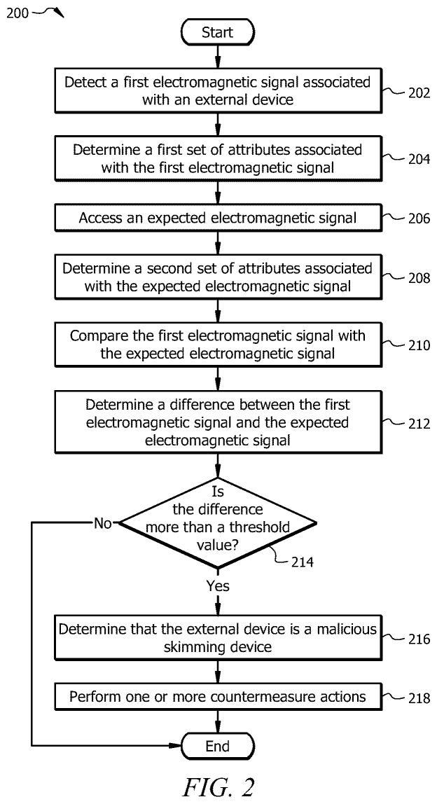

As described above, previous technologies fail to provide efficient and reliable solutions for detecting and mitigating skimming devices. Embodiments of the present disclosure and its advantages may be understood by referring to FIGS. 1 through 2. FIGS. 1 through 2 are used to describe systems and methods for detecting and mitigating skimming devices, according to some embodiments.

### System Overview

FIG. 1 illustrates an embodiment of a system 100 that is generally configured to detect and mitigate skimming/malicious devices that attempt to gain access to information associated with a portable device. In some embodiments, the system 100 comprises a portable device 120. The portable device 120 may be communicatively coupled to other computing devices via a network 110. In some embodiments, the system 100 may further comprise a communication station 104. A user 102 may use the portable device 120 to perform certain operations, such as communicating with other devices (e.g., communication stations 104), sending and receiving data, and interacting with other devices, among others. In other embodiments, system 100 may not have all of the components listed and/or may have other elements instead of, or in addition to, those listed above.

In general, the system 100 improves the unauthorized access attempt detection and mitigation techniques with respect to unauthorized attempts to remotely access portable devices 120. In the current systems, malicious devices (such as malicious scanning devices) pose a significant threat to people and organizations, leading to unauthorized access to sensitive information and compromised sensitive information associated with people and organizations. Existing security measures are insufficient in detecting and neutralizing skimming devices, necessitating the development of more robust solutions to protect against skimming devices. Bad actors may install a skimming device at a particular location where users typically use their portable devices 120. For example, a skimming device may be installed within, above, or underneath a kiosk, a legitimate device or a station, among others. If such skimming devices are left undetected, they may scan and access information associated with portable devices 120, for example, when the portable devices 120 are used to communicate with legitimate communication devices.

The disclosed system provides a solution to these and other technical problems arising in the realm of information security and network security. The disclosed system 100 addresses the challenge of device skimming by equipping portable devices with technology capable of detecting and mitigating unauthorized skimming devices. When a skimming device is detected, the system 100 triggers a mechanism within the portable device 120 to mitigate the skimming device, preventing further unauthorized access to data available at the portable device. Additionally, the system 100 includes an alerting mechanism to notify the host machine and relevant authorities of the presence and location 198 of the skimming device, facilitating rapid response and mitigation efforts.

In some embodiments, the disclosed system 100 is configured to detect a presence of a skimming device 180 based on a deviation in electromagnetic signals 114 caused by the skimming device 180. The electromagnetic field sensor circuit 126 associated with the portable device 120 may detect deviations in electromagnetic signals within its detection range. In some embodiments, the disclosed system 100 is configured to perform one or more countermeasure actions 178 to mitigate the skimming device 180. In some examples, the countermeasure actions 178 may include emitting a short-range electromagnetic signal 112 directed toward the skimming device 180, altering magnetic properties of the magnetic stripe 168 of the portable device 120, deploying a retractable shield to cover at least a portion of the surface of the portable device 120, project/spray an adhesive substance 160 toward the skimming device 180, communicate notification alert messages 188 to the user 102 and authorities indicating the location 198 of the skimming device 180 and the detected attempt to scan/access the portable device 120, implementing security measures, including cryptographic protocols, authentication mechanisms, and tamper-resistant enclosure, anti-reply mechanism, among others. In this way, the disclosed system 100 improves the unauthorized access attempt detection and mitigation techniques via skimming devices.

### System Components

### Network

Network 110 may be any suitable type of wireless and/or wired network. The network 110 may be connected to the Internet or public network. The network 110 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., Wi-Fi, WiGig, WiMAX, etc.), a long-term evolution (LTE) network, a universal mobile telecommunications system (UMTS) network, a peer-to-peer (P2P) network, a Bluetooth network, a near-field communication (NFC) network, and/or any other suitable network. The network 110 may include fiber optics, optical fibers, and the like. The network 110 may be configured to support any suitable type of communication protocol as would be appreciated by one of ordinary skill in the art.

### Example Communication Station

The communication station 104 may be a computing device configured to process data and perform certain operations, including interacting with portable devices 120, and communicating data with other devices, among others. In some examples, the communication station 104 may be a kiosk, an automated teller machine, a card reader, a cash register, a dispensing machine, and the like. In some embodiments, the communication station 104 may be portable or stationary. In some embodiments, the communication station 104 may comprise a terminal device for dispensing items, tickets, scrip, airline tickets, displaying information on its display screen about a service or item, etc. In some embodiments, the communication station 104 may allow users 102 to withdraw cash, and check balances, and make deposits interactively using, for example, a magnetically encoded card, a check, etc., among other services that the communication station 104 provides.

This disclosure contemplates communication station 104 being any appropriate device for sending and receiving communications over network 110. The communication station 104 may include a user interface, such as a display, a microphone, a keypad, or other appropriate terminal equipment usable by users 102. The communication station 104 may include a hardware processor, memory, and/or circuitry configured to perform any of the functions or actions of communication station 104 described herein. For example, the communication station 104 may include a processor in signal communication with a memory and a network interface. The memory of the communication station 104 may store a software application designed using software code that when executed by the processor of the communication station 104, causes the processor of the communication station 104 to perform the functions of communication station 104.

### Example Portable Device

The portable device 120 may be a computing device configured to process data, detect the presence of skimming devices 180, and perform certain operations to mitigate the skimming device 180, among other operations. In some embodiments, the portable device 120 may be a thin apparatus that at least partially may be inserted into a slot of a kiosk (an example communication station 104), where the internal components of the kiosk may read and access information displayed on the portable device 120 and/or stored in the memory 170 of the portable device 120. In some embodiments, the portable device 120 may be configured to communicate data with the kiosk with wireless communication when the portable device 120 is within a threshold communication range from the kiosk.

In some embodiments, the portable device 120 may be configured to communicate with legitimate device communication stations 104 via wireless communication when the portable device 120 is within a threshold communication range from the legitimate device communication stations 104. In some embodiments, the portable device 120 may communicate with communication station 104 via wireless communication, such as NFC, Bluetooth, and the like. For example, portable device 120 may be a card device, a telephone, a mobile phone, a computer, a laptop, a tablet, an automated assistant, and/or a cash register. This disclosure contemplates portable device 120 being any appropriate device for sending and receiving communications over network 110. As an example and not by way of limitation, portable device 120 may be a computer, a laptop, a wireless or cellular telephone, an electronic notebook, a personal digital assistant, a tablet, or any other device capable of receiving, processing, storing, and/or communicating information with other components of system 100. The portable device 120 may also include a user interface, such as a display, a microphone, a keypad, or other appropriate terminal equipment usable by user 102. Portable device 120 may include a hardware processor, memory, and/or circuitry configured to perform any of the functions or actions of portable device 120 described herein. For example, a software application designed using software code may be stored in the memory and executed by the processor to perform the functions of portable device 120.

In some examples, the portable device 120 may be used to access a digital profile and digital wallet associated with a user 102. In the illustrated embodiment, the portable device 120 includes a processor 122 in signal communication with sensor circuits 124, communication interface 130, disablement module 132, and a memory 170. In certain embodiments, the portable device 120 may be configured as shown or in other configurations.

The processor 122 comprises one or more processors. The processor 122 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The processor 122 may be a programmable logic device, a microcontroller, a microprocessor, or any suitable combination of the preceding. The one or more processors are configured to process data and may be implemented in hardware or software. For example, the processor 122 may be 8-bit, 16-bit, 32-bit, 64-bit, or of any other suitable architecture. The processor 122 may include an arithmetic logic unit (ALU) for performing arithmetic and logic operations, processor 122 registers the supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute instructions (e.g., software instructions 172) to implement the operations of the processor 122. In this way, processor 122 may be a special-purpose computer designed to implement the functions disclosed herein. In an embodiment, the processor 122 is implemented using logic units, FPGAs, ASICs, DSPs, or any other suitable hardware. The processor 122 is configured to operate as described in FIGS. 1-2. For example, the processor 122 may be configured to perform one or more operations of the operational flow of the system 100 described in FIG. 2 and one or more operations of method 200 as described in FIG. 2.

### Sensor Modules

The sensor circuits 124 may include an electromagnetic field sensor circuit 126 and a tamper detection circuit 128. The sensor circuits 124 monitor the electromagnetic environment surrounding the portable device 120 to detect any unauthorized skimming devices that may emit an electromagnetic signal. The electromagnetic field sensor circuit 126 may be implemented by hardware circuit (e.g., ASIC) and/or software (e.g., an electromagnetic signal detection code) implemented in a microcontroller. The electromagnetic field sensor circuit 126 may generally be configured to detect electromagnetic signals within its detection range (e.g., five feet, two feet, etc.). The electromagnetic field sensor circuit 126 is configured to detect and analyze the electromagnetic signatures emitted by portable device communication stations 104 during interactions with them. The electromagnetic field sensor circuit 126 detects electromagnetic signatures associated with the device communication stations 104. The electromagnetic signatures may correspond to specific patterns of electromagnetic waves with known frequencies and amplitudes.

When a portable device 120 is swiped or inserted into a communication station 104, the communication station 104 emits electromagnetic signals to communicate with the portable device 120's chip, magnetic stripe, and/or communication interface 130. The sensor circuits 124 monitor these signals and captures data embedded (e.g., encoded and/or modulated) into their frequency carriers, amplitude, and duration. The captured data may be used to facilitate an interaction and communication with the communication station 104.

The tamper detection circuit 128 may be implemented by a hardware circuit (e.g., ASIC) and/or software (e.g., an electromagnetic signal detection code) implemented in a microcontroller. The tamper detection circuit 128 is generally configured to detect unauthorized attempts to access or modify the portable device 120's internal circuitry. The tamper detection circuit 128 may be configured to perform operations, such as impedance monitoring, voltage threshold detection, and circuit continuity checks, to identify anomalies indicative of tampering. Any detected tampering triggers the disablement module 132 to perform one or more operations described herein. Anomalies in the electromagnetic signatures emitted by communication station 104 may arise due to various factors, including the presence of unauthorized skimming devices 180 or modifications to legitimate communication stations 104. These anomalies deviate from the expected electromagnetic patterns associated with standard interactions with the communication station 104. For example, the presence of a skimming device 180 may introduce additional electromagnetic interference or alter the characteristics of the electromagnetic field surrounding the communication station 104. The processor 122 (e.g., via the sensor circuit 124) compares the detected electromagnetic signatures against predefined thresholds or expected electromagnetic patterns. If a deviation exceeding predetermined thresholds is detected, the portable device 120 interprets them as anomalies indicative of potential skimming activity. Subsequently, the disablement module 132 is activated to mitigate the threat posed by the detected skimming device 180.

Communication interface 130 is configured to enable wired and/or wireless communications (e.g., via network 110). The communication interface 130 is configured to communicate data between the portable device 120 and other devices, systems, and domains. For example, the communication interface 130 may comprise an embedded subscriber identity module (eSIM) interface, NFC interface, a Bluetooth interface, a Zigbee interface, a Z-Wave interface, a radio-frequency identification (RFID) interface, a Wi-Fi interface, a LAN interface, a WAN interface, a MAN interface, a PAN interface, aWPAN interface, a modem, a switch, and/or a router. The processor 122 is configured to send and receive data using the communication interface 130. The communication interface 130 may be configured to use any suitable type of communication protocol as would be appreciated by one of ordinary skill in the art.

Memory 170 may be a non-transitory computer-readable medium. The memory 170 may be volatile or non-volatile storage device. The memory 170 may comprise a read-only memory (ROM), random-access memory (RAM), ternary content-addressable memory (TCAM), dynamic random-access memory (DRAM), and static random-access memory (SRAM). Memory 170 may be implemented using one or more disks, tape drives, solid-state drives, and/or the like. Memory 170 is operable to store the software instructions 172, and/or any other data or instructions. The software instructions 172 may comprise any suitable set of instruction messages 186, logic, rules, or code operable to execute the operations of the processor 122.

### Disablement Module

The disablement module 132 may be implemented by hardware devices and circuits. The disablement module 132 may be an integral part of the portable device 120's security architecture, configured to mitigate unauthorized skimming devices 180 detected by the sensor circuit 124. Upon detection of anomalous electromagnetic signatures indicative of potential skimming activity, the disablement module 132 is activated to render the skimmer device at least partially inoperative.

In some embodiments, the disablement module 132 may operate by selectively disrupting the functionality of the skimming device 180 through targeted electromagnetic interference and/or physical intervention. Upon receiving an alert message from the sensor circuit 124 regarding the presence of a skimmer device, the processor 122 may execute software instructions 172 to trigger the disablement module 132 to perform one or more of its operations described herein. For example, in response, the disablement module 132 may execute a series of countermeasure actions 178 to disable some or all operations of the skimming device 180. In some embodiments, the disablement module 132 may include a magnetic field modulation device 134, retractable shielding device 146, adhesive projecting device 148, and electromagnetic signal emitter circuit 150. The components of the disablement module 132 may be implemented by nano, micro-electronic circuits, micro-electromechanical systems (MEMS), and other components.

### Electromagnetic Signal Emitter Circuit

The electromagnetic signal emitter circuit 150 may be implemented by hardware comprising a circuit and configured to generate and emit electromagnetic signals 112. The circuit may include signal generators, amplifiers, and antennas, among other components. The electromagnetic signal emitter circuit 150 may generate and emit electromagnetic signals 112 at specific frequencies, amplitudes, power, and direction. The electromagnetic signal emitter circuit 150 may direct the emission of the electromagnetic signals 112 toward a specific direction using a unidirectional antenna. For example, the processor 122 may determine/estimate the distance 196 between the portable device 120 and the skimming device 180 and the location 198 of the skimming device 180 with respect to the portable device 120 based on the direction from which electromagnetic interferences or signals 114 propagated from the skimming device 180 and the magnitude of the electromagnetic interferences or signals propagated from the skimming device 180.

In response, the processor 122 may send instruction messages 186 to the electromagnetic signal emitter circuit 150 to generate an electromagnetic signal 112 with a specific power, frequency, direction, and amplitude that interferes with (e.g., at least partially counter) the skimming device 180's functions and electromagnetic signals 114. The specific power, frequency, direction, and amplitude may be dynamically adjusted based on feedback from the sensor circuits 124 to allow for targeting the skimming device 180, rather than other nearby devices.

The instruction messages 186 from the processor 122 may further indicate the direction of the emission based on the estimated location 198 of the skimming device 180 with respect to the portable device 120. Thus, the electromagnetic signal emitter circuit 150 may configure its unidirectional antenna to emit the electromagnetic signals 112 toward the skimming device 180. The emission direction may be adapted based on feedback regarding location changes of the skimming device 180, power changes, and amplitude changes of the anomalous electromagnetic signals 114 propagated from the skimming device 180. The electromagnetic signal emitter circuit 150 may be activated upon detection of unauthorized skimming activity, similar to that described above.

### Magnetic Field Modulation Device

The magnetic field modulation device 134 may include hardware circuits configured to modify the magnetic properties of the portable device 120's magnetic stripe 168. In some embodiments, when triggered by the detection of skimming activity, the magnetic field modulation device 134 may apply controlled alterations to the magnetic field of stripe 168, making it at least partially unreadable by unauthorized skimming devices 180. The magnetic field modulation device 134 may include magnetic field modulation circuit 136, control circuitry 138, power supply, activation circuit 142, and feedback loop circuit 144.

The magnetic field modulation circuit 136 may include hardware circuits, coils, or other magnetic field generators capable of emitting electromagnetic fields with specific properties. These electromagnetic fields are directed towards the magnetic stripe 168 upon activation, inducing controlled changes in its magnetic characteristics. For example, the processor 122 may send an instruction message 186 to the electromagnetic field modulation device 134 indicating to initiate altering the magnetic field of the magnetic stripe 168. In response, the magnetic field modulation device 134 (e.g., via the magnetic field modulation circuit 136) may generate and emit electromagnetic fields 111 toward the magnetic stripe 168 to alter its magnetic characteristics.

The control circuitry 142 comprises a hardware circuit configured to control the operation of the magnetic field modulation circuit 136 based on input from the sensor circuits 124. The processor 122 (e.g., via the control circuitry 142) interprets signals indicating the presence of unauthorized skimming activity and coordinates the activation of the magnetic field modulation circuit 136 to initiate the countermeasure response.

The power supply 140 comprises a hardware circuit and is configured to provide the necessary electrical energy to drive the other components of the magnetic field modulation device 134. In some embodiments, the power supply 140 may include an embedded battery and/or an energy harvesting module. The embedded battery may include a hardware battery structure and be implemented by a miniature rechargeable or non-rechargeable battery that is thin and compact, and configured to fit within the dimensions of the portable device 120 without increasing its thickness. The energy harvesting module may include a hardware energy-saving device configured to utilize energy harvesting techniques to generate electrical power from ambient sources such as electromagnetic radiation, and mechanical vibrations, among others. In some embodiments, piezoelectric materials or miniature solar cells embedded within the portable device 120 may capture and convert these sources of energy into electrical power to supplement or replace the battery as needed. In some embodiments, the power supply 140 may use a portion of the power supply associated with the portable device 120.

The activation circuit 142 may include a hardware circuit configured to activate the magnetic field modulation device 134. The activation circuit 142 may be triggered by the detection of skimming activity, according to some embodiments. The activation circuit 142 may be based on sensor data associated with the sensor circuits 124 indicating anomalous device scanning behavior, signaling the need for counteraction. Upon the detection of anomalous device scanning behavior (e.g., anomalous electromagnetic signals 114 causing a deviation from expected electromagnetic signals 116), the processor 122 may instruct (via the instruction messages 186) the magnetic field modulation device 134 to initiate the modulation of the properties of the magnetic stripe 168. In response, the activation circuit 142 activates the control circuitry 142 to initiate the modulation of the properties of the magnetic stripe 168 to render it at least partially unreadable/incoherent to the skimming device 180.

The feedback loop circuit 144 may be a hardware circuit configured to maintain the effectiveness and performance of the magnetic modulation process. The feedback loop circuit 144 enables the monitoring of the countermeasure actions'impact on the magnetic stripe 168 (e.g., magnetic modulation process) and adjusts the modulation parameters as needed to render the magnetic stripe 168 at least partially unreadable/incoherent to the skimming device 180. The skimming device 180 not being able to read/access the magnetic stripe 168 leads to reducing (or preventing) unauthorized data extraction by the skimming device 180.

### Retractable Shielding Device

The retractable shielding device 146 may be implemented by hardware circuits and physical devices, including shielding elements 152, actuators and motors 154, and a locking mechanism 156, and is generally configured to expand across the surface of the portable device 120 to create a physical shield or barrier to block certain intrusions by the skimming device 180. The retractable shielding device 146 may include shielding elements 152 operably coupled and connected to actuators and motors 154 and a locking mechanism 156. The shielding elements 152 may be positioned to physically obstruct electromagnetic signals 114 from the skimming device 180 upon activation.

In some embodiments, the shielding elements 152 may be implemented by nanotubes, nano-rods, other nano-structures, and/or MEMS. In some embodiments, the shielding elements 152 may be composed of durable nano-or micro-electronic materials capable of withstanding tampering attempts. In some embodiments, the shielding elements 152 may be composed of thin layer of metal, sheet metal, metal screen, metal foam, and the like. In some embodiments, the metal used in the shielding elements 152 may include copper, brass, nickel, silver, steel, tin, aluminum, and/or the like. In some embodiments, the shielding elements 152 may be flexible, semi-flexible, semi-rigid, or rigid. In some embodiments, the shielding elements 152 may include a single piece or multiple pieces coupled together via mechanical joints or linkages.

When triggered, the shielding elements 152 may be deployed by the actuators and motors 154 to envelop and encase at least a part of the portable device 120. This may block electromagnetic signals 114 around the portable device 120. Thus, the unauthorized attempt by the malicious skimming device 180 to access the portable device 120 may be blocked. When the malicious activity is passed, the shielding elements 152 may be retracted by the actuators and motors 154. In some embodiments, upon detection of skimming activity by the sensor circuits 124, the processor 122 may initiate an activation signal to trigger the retractable shielding device 145 to deploy the shielding elements 152.

The actuators and motors 154 may include hardware circuits and configured to move the shielding elements 152 to either retract them or release them to encase the portable device 120. The locking mechanism 156 may include a hardware circuit and be configured to lock the shielding elements in place, e.g., along a side of the portable device 120. In some embodiments, the locking mechanism 156 may include an S-shaped locking member with hooks at each end, where the S-shaped locking member may be configured to releasably engage with catches that are configured to secure the shielding elements in a locked position when engaged and allow for release of the shielding elements 152 when the actuators and motors 154 are activated. The activation signal prompts the release mechanism to disengage the locking mechanism 156 holding the shielding elements 152 in place. This action allows them to extend outward from the portable device's surface.

The actuators or motors 154 extend the shielding elements 152, deploying them to surround and encase the portable device 120. Once deployed, the shielding elements 152 physically obstruct access to the portable device 120. This prevents the skimming device 180 from capturing any data from the portable device 120.

The retractable shielding elements 152 may lead to marginal interference to legitimate interactions between the portable device 120 and other devices, such as the communication stations 104. The shielding elements 152 retract back into a retracted portion once the skimming threat has been neutralized or passed.

### Adhesive Projecting Device

The adhesive projecting device 148 may be implemented by hardware devices and circuits and include adhesive substance 160, pumps and actuators 162, and nozzle arrays 164. The adhesive substances 160 are configured to adhere to the surface of the skimming device 180 upon activation. These adhesive substances 160 are configured to bond rapidly and securely to at least partially immobilize the skimming device 180 and prevent its removal or tampering. Thus, this countermeasure may lead to the skimming device 180 to remain incapacitated until proper authorities can obtain it for investigation.

The adhesive substances 160 are stored within the disablement module 132 integrated into the portable device 120's structure. Dedicated compartments or chambers within the portable device 120 house the adhesive formulations, protecting them until activation. Upon detection of skimming activity, the portable device 120 card initiates the deployment sequence, releasing the adhesive substances 160 from their storage compartments. This process is facilitated by internal mechanisms such as miniature pumps and/or actuators 162, which transport the adhesive substance 160 to the surface of the portable device 120 for projection onto the skimming device 180.

Once released, the adhesive substances 160 are projected onto the surface of the skimming device 180 using integrated delivery systems of the portable device 120. These delivery systems utilize microfluidic channels, nozzle arrays, or other mechanisms (collectively referred to herein as nozzle arrays 164) to control the flow and direction of the adhesive to ensure accurate targeting of the skimming device 180. The adhesive substance 160 is projected with sufficient force and precision to achieve at least partial coverage of the surface of the skimming device 180 to facilitate rapid bonding and immobilization upon contact. The projection process is finely tuned to increase adhesive coverage while reducing waste of the adhesive. The force and direction of the adhesive projection may be based on the estimated distance 196 between the portable device 120 and the skimming device 180, and the estimated location 198 of the skimming device 180 with respect to the portable device 120, which may be determined similar to that described above.

In some embodiments, the adhesive substances 160 comprise specialized polymers selected for their adhesive properties, durability, and rapid curing characteristics. In some embodiments, the polymers may include synthetic compounds configured to exhibit strong adhesive bonds upon contact with surfaces. In some embodiments, the adhesive substances 160 may include additives or accelerators configured to promote rapid bonding upon contact. These agents may facilitate the formation of strong adhesive bonds within seconds of deployment.

In some embodiments, the adhesive substances 160 may incorporate pressure-sensitive adhesives (PSAs) that require less or minimal pressure to initiate bonding compared to others. This property allows the adhesive substances to adhere securely to the surface of the skimming device 180 upon contact, without the need for additional curing or setting time. In some embodiments, the adhesive substances 160 may be configured to form non-reversible bonds upon contact with the skimming device 180. This may lead to making the removal of the skimming device 180 exceedingly difficult. Once bonded, the adhesive creates a strong attachment to immobilize the skimming device 180 to prevent its detachment or displacement.

Before deployment, the adhesive formulations undergo rigorous compatibility testing to ensure their effectiveness across a range of surfaces commonly encountered in skimming devices 180. This testing may include assessments of adhesion strength, durability, and resistance to environmental factors such as thermal data and moisture. In cases where the adhesive substances 160 may encounter human skin or other sensitive surfaces, additional considerations for biocompatibility may be incorporated into the formulation. This may lead to the adhesive materials being safe for use and do not pose any physical risks to individuals.

### Software-Based Countermeasure Actions

In addition to the physical countermeasures described herein, the disablement module 132 includes an integrated communication interface 130 configured to trigger alarm systems or notify designated authorities upon detection of skimming activity. The communication interface 130 may utilize wireless or wired connections to transmit alerts, facilitating rapid response efforts by law enforcement or security personnel. By promptly alerting relevant parties to the presence of a skimming device 180, this feature enhances deterrence and enables timely intervention to mitigate potential risks.

In some embodiments, the activation of the disablement module 132 may be triggered automatically upon the detection of anomalous electromagnetic signatures associated with the electromagnetic signals 114 detected by the sensor circuits 124. Once the sensor circuit 124 identifies a potential skimming device 180, it transmits sensor data 182 to the disablement module 132 and the processor 122. The processor 122 may send instruction messages 186 to the displacement module 132 to execute one or more countermeasure actions 178.

In some embodiments, the disablement module 132 may operate autonomously, requiring no direct intervention from the user 102 or external entities. A digital command packet containing specific instruction messages 186 for activating the countermeasure actions 178 may be sent to the disablement module 132. The instruction messages 186 may include information such as the location 198 of the skimming device 180 with respect to the portable device 120, the distance 196 between the skimming device 180 and the portable device 120, and the nature of the countermeasures to be deployed.

The instruction messages 186 may be formatted using a standardized communication protocol, such as Bluetooth low energy (BLE) or NFC. Each instruction message 186 may be uniquely encoded to ensure secure transmission and prevent tampering or interception by unauthorized parties. Upon receiving the instruction messages 186, the disablement module 132 may decode the instruction messages 186 and execute the corresponding actions per the transmitted instruction messages 186.

To reduce the probability of unauthorized activation or manipulation of the disablement module 132, security measures 191 may be implemented within the architecture of the portable device 120. The security measures 191 may be implemented by the processor 122 executing software instructions 172 and include cryptographic protocols, authentication mechanisms, and tamper-resistant enclosures to safeguard against unauthorized access or tampering. Additionally, the disablement module 132 may incorporate anti-replay mechanisms to prevent adversaries from replaying captured signals to trigger false alarms or evade detection.

In some embodiments, the cryptographic protocols may utilize industry-standard cryptographic algorithms such as advanced encryption standard (AES) or Rivest-Shamir-Adleman (RSA) for secure communication, protocols, such as transport layer security (TLS) or datagram transport layer security (DTLS) for end-to-end encryption of communication channels, and operate by encrypting activation signals transmitted between the sensor circuit 124, the processor 122, and the disablement module 132.

In some embodiments, the authentication mechanisms may employ challenge-response protocols or digital signatures for mutual authentication between the sensor module and the disablement mechanism, utilize cryptographic keys or certificates to verify the authenticity of communication endpoints, and operate based on the principle of verifying the identity of both parties involved in the communication process to prevent unauthorized entities from impersonating legitimate components.

In some embodiments, the tamper-resistant enclosures may utilize hardened materials such as hardened steel or reinforced polymers for physical casing, incorporate anti-tamper mechanisms such as sealants or breakage sensors to detect and respond to unauthorized attempts to access internal components and facilitate the disablement module 132 remains securely housed within the portable device 120 to protect it from physical attacks or tampering attempts.

In some embodiments, the anti-replay mechanisms may implement nonce-based schemes or timestamping mechanisms to generate unique activation signals for each skimming detection event, utilize cryptographic hashes or digital signatures to validate the freshness and authenticity of received activation signals, and prevent adversaries from replaying previously captured signals by ensuring that each activation signal is tied to specific contextual information or time parameters.

The communication interface 130 may facilitate communication between the portable device 120 and external entities to allow transmission of security alerts and status updates (collectively referred to herein as alert message 188). Through the communication interface 130, the portable device 120 may relay information regarding detected skimming activity, disablement events, countermeasure actions, and operational status to designated recipients, such as organizations or law enforcement agencies.

In some embodiments, the communication interface 130 leverages wireless communication protocols, such as NFC to establish communication links with external devices via networks 110. The wireless technologies enable secure and efficient data transmission over short distances to facilitate compatibility with existing communication station 104 infrastructure and mobile devices.

In some embodiments, the communication transmitted via the communication interface 130 may be encrypted using cryptographic algorithms and protocols to protect the confidentiality and integrity of the transmitted data. Secure key exchange mechanisms and authentication protocols may be employed to verify the identity of communication endpoints and prevent unauthorized access or tampering.

In some embodiments, the secure key exchange mechanism may include elliptic curve Diffie Hellman (ECDH), and RSA Key Exchange integrated with TLS, among others. Each party may generate its public and private keys based on elliptic curve cryptography. For example, the involved parties may exchange their public keys over the insecure channel, and using their private key and the other party's public key, they compute a shared secret. The shared secret may be used to derive encryption keys for secure communication.

In some embodiments, the authentication protocols hash-based message authentication code (HMAC), digital signatures, among others. The cryptographic technique may generate a unique hash value by combining a secret key with the message content. The resulting hash is then sent along with the message. Upon receipt, the recipient recalculates the hash using the same key and verifies it against the transmitted hash to ensure message integrity.

In some embodiments, digital signatures may utilize public key cryptography to provide authentication and integrity for messages. The sending device may generate a unique digital signature using its private key, which is then verified by the recipient using the sending device's public key. This facilitates that the message was indeed sent by the claimed sender and that it has not been altered in transit.

In some embodiments, the communication interface 130 may enable monitoring of security events and operational status, allowing users to respond promptly to detected threats or incidents. Security alerts generated by the processor 122, for example, via the sensor circuit 124 and disablement module 132 may be transmitted via the communication interface to designated recipients, facilitating rapid incident response and mitigation.

In some embodiments, the security measures 191 may include an alerting system. The alerting system may serve as a security component of the security infrastructure of the portable device 120 to provide notifications and alerts to designated recipients upon the detection of skimming activity or disablement events. By notifying the recipients of security incidents, the alerting system enables timely response and mitigation efforts, enhancing overall security posture and mitigating potential risks.

In some embodiments, the alerting system may monitor the operational status and security events associated with the portable device 120, including anomalous electromagnetic signatures detected by the sensor circuit 124 and disablement events triggered by the disablement module 132. Upon detecting a security event, such as the presence of a skimmer device 180 or the activation of the disablement module 132, the alerting system generates an alert notification for dissemination to designated recipients.

In some embodiments, the alert notifications generated by the alerting system may be transmitted via multiple communication channels to ensure timely delivery and receipt by the intended recipients. The communication channels may include text messages, electronic mail, push notifications, or dedicated mobile applications, depending on the preferences and requirements of the recipients. By employing a multi-channel notification approach, the alerting system enhances the likelihood of prompt response and mitigation of security incidents.

In some embodiments, the alerting system may provide centralized monitoring and management capabilities to allow designated administrators or security personnel to oversee security events and incident response efforts in a timely manner. Through a centralized dashboard or management console, administrators may view detailed event logs, track the status of alert notifications, and coordinate response actions effectively. Additionally, the alerting system may support customizable escalation policies and automated response workflows to streamline incident management processes and ensure compliance with established security protocols.

### Operational Flow for Detecting and Mitigating Skimming Devices

In operation, the portable device 120 may perform one or more countermeasure actions 178 in response to a detection of an anomalous event that may indicate an unauthorized attempt to access the portable device 120, e.g., via skimming devices 180. In an example scenario, the user 102 may carry the portable device 120 to a place where a skimming device 180 may be present, e.g., installed next to a legitimate communication station 104. The user 102 may want to use the communication station 104 to scan the portable device 120 or perform an action via the portable device 120.

The operational flow of the system 100 may begin when an anomalous event is detected. In some embodiments, the sensor circuits 124 may detect electromagnetic signals 114 emitted from a skimming device 180 when the skimming device 180 comes within a detection range of the sensor circuits 124, similar to that described above. The sensor circuits 124 may further detect the expected electromagnetic signals 116 emitted from the communication station 104, similar to that described above. In response, the sensor circuits 124 may sensor data 182 to the processor 122, where the sensor data 182 may include the detected electromagnetic signals 114 and 116.

The processor 122 may detect that the electromagnetic signals 114 are associated with and/or originated from an external device, for example, due to a deviation idle mode where no electromagnetic signals are detected. In response, the processor 122 (e.g., via the sensor circuits 124) may determine a first set of attributes 176 associated with the electromagnetic signals 114. The first set of attributes 176 may include a power level, a frequency range (e.g., a frequency range of 13.56 MHz to 2.4 GHz which covers various wireless communications, such as NFC, Wi-Fi, and the like), and an electromagnetic wave pattern/signature, among other attributes associated with the electromagnetic signals 114.

The processor 122 may evaluate the electromagnetic signals 114. In this process, the processor 122 may access the records of expected electromagnetic signals 116 associated with the communication station 104. The expected electromagnetic signals 116 may further be associated with legitimate and authorized operations experienced by the portable device 120. For example, the expected electromagnetic signals 116 may include historical records of electromagnetic signals 112 emitted from a communication station 104 and detected by the sensor circuits 124 when no skimming device 180 was present.

The processor 122 may determine a second set of features or attributes 174 associated with the expected electromagnetic signals 116. The second set of features or attributes 174 may include a power level, a frequency range (e.g., a frequency range of 13.56 MHz to 2.4 GHz which covers various wireless communications, such as NFC, Wi-Fi, and the like), and an electromagnetic wave pattern/signature, among other attributes associated with the electromagnetic signals 116. To evaluate the electromagnetic signals 114, the processor 122 may compare the electromagnetic signals 114 with the expected electromagnetic signal 116. To this end, the processor 122 may compare each of the first set of attributes 176 with a counterpart or corresponding attribute 174 from among the second set of attributes 174.

Based on the comparison, the processor 122 may determine a difference 194 between the electromagnetic signals 114 and the expected electromagnetic signals 116. For example, the processor 122 may determine a difference 194 in frequency, amplitude, and electromagnetic pattern/signature, among others. In some embodiments, the processor 122 may determine a difference 194 between each attribute 174 and the corresponding attribute 176, and determine an aggregate difference 194 based on the set of differences 194. In some embodiments, the processor 122 may determine a weighted sum of the set of differences 194. For example, the processor 122 may assign a weight to each difference 194 based on the respective attribute's historically determined importance in identifying skimming devices 180 or anomalous activities, and calculate a weighted sum of differences 194.

The processor 122 determines whether the determined difference 194 is more than a threshold value 192. For example, the threshold value 192 may be within the range of 10% to 30% deviation from the expected electromagnetic signals 116, depending on the specific implementation and security requirements. In other examples, the threshold value 192 may be within any other percentage range of the deviation from the expected electromagnetic signals 116. If is determined that the difference 194 exceeds the threshold value 192, the processor 122 may determine that the external device is a malicious skimming device 180 attempting to access information associated with the portable device 120, and that the detected electromagnetic signals 114 are associated with the malicious skimming device 180. In response, the processor 122 (e.g., via the disablement module 132) may perform one or more countermeasure actions 178.

The processor 122 may send the instruction messages 186 to the disablement module 132. The sensor circuits 124 may send the sensor data 182 to the disablement module 132. The disablement module 132 may use the received data to activate one or more of its components to perform one or more countermeasure actions 178.

In some embodiments, the countermeasure action 178 may include the emission of a particular electromagnetic signal 112 via the electromagnetic signal emitter circuit 150, similar to that described above. The particular electromagnetic signal 112 may be directed towards the skimming device 180 based on the location 198, and have a propagation power to reach the skimming device 180 without interfering with other devices, including the communication station 104.

In some embodiments, the particular electromagnetic signal 112 may be configured to counter at least a portion of the electromagnetic field generated by the skimming device 180. To this end, the emitter circuit 150 may set the emission parameters of the electromagnetic signal 112 dynamically to counter at least a portion of the electromagnetic field generated by the skimming device 180.

In some embodiments, the countermeasure action 178 may include changing the modulation of the magnetic stripe 168, where changing the modulation of the magnetic stripe 168 may include changing one or more characteristics associated with the magnetic stripe 168, similar to that described above. The characteristics associated with the magnetic stripe 168 may include a magnetic signal frequency, a magnetic signal amplitude, or a bit stream associated with the magnetic stripe 168. The bit stream associated with the magnetic stripe 168 may be a sequence of binary data that encodes information stored on the magnetic stripe 168, such as user information, documents, numbers, addresses, and other relevant data.

In some embodiments, the countermeasure action 178 may include activating the retractable shielding device 148 to enclose at least the portion of the surface of the portable device 120, similar to that described above. In some embodiments, the countermeasure action 178 may include projecting the adhesive substance 160 toward the location 198 of the skimming device 180, similar to that described above. In some embodiments, the countermeasure action 178 may include communicating an alert message 188 that indicates the skimming device 180 is detected and that the countermeasure action 178 is performed. In some embodiments, the processor 122 may detect the location 198 of the skimming device 180 with respect to the portable device 120 based on the electromagnetic signals 114. The processor may include the location 198 in the instruction messages 186 and indicate to perform the countermeasure actions 178. In some embodiments, the countermeasure action 178 may include encrypting transmission signals 108 with an encryption key, where the encrypted transmission signals 108 are associated with an interaction with another device, such as the communication station 104.

### Method for Detecting and Mitigating Skimming Devices

FIG. 2 illustrates an example flowchart of a method 200 for detecting and mitigating skimming devices, according to some embodiments. Modifications, additions, or omissions may be made to method 200. Method 200 may include more, fewer, or other operations. For example, operations may be performed in parallel or in any suitable order. While at times, it is discussed that the system 100, portable device 120, or components of any thereof perform some operations, any suitable system or components of the system may perform one or more operations of the method 200. For example, one or more operations of method 200 may be implemented, at least in part, in the form of software instructions 172 of FIG. 1, stored on a tangible non-transitory machine-readable medium (e.g., memory 170 of FIG. 1) that, when run by one or more processors (e.g., processor 122 of FIG. 1), may cause the one or more processors to perform operations 202-218.

At operation 202 the portable device 120 detects a first electromagnetic signal 114 associated with an external device 180, similar to that described in FIG. 1.

At operation 204, the portable device 120 determines a first set of attributes 176 associated with the first electromagnetic signal 114, similar to that described in FIG. 1.

At operation 206, the portable device 120 accesses an expected electromagnetic signal 116, e.g., from the memory 170.

At operation 208, the portable device 120 determines a second set of attributes 174 associated with the expected electromagnetic signals 116, similar to that described in FIG. 1.

At operation 210, the portable device 120 compares the first electromagnetic signal 114 with the expected electromagnetic signal 116, similar to that described in FIG. 1.

At operation 212, the portable device 120 determines a difference 194 between the first electromagnetic signal 114 and the expected electromagnetic signal 116, similar to that described in FIG. 1.

At operation 214, the portable device 120 determines whether the difference 194 is more than a threshold value 192. If it is determined that the difference 194 is more than the threshold value 192, the method 200 proceeds to operation 216. Otherwise, the method 200 ends.

At operation 216, the portable device 120 determines that the external device is a malicious skimming device 180.

At operation 218, the portable device 120 performs one or more countermeasure actions 178, similar to that described in FIG. 1.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S. C. § 112(f), as it exists on the date of filing hereof, unless the words “means for” or “step for” are explicitly used in the particular claim.

1. A system comprising:
a memory configured to store an indication of an expected electromagnetic signal associated with at least one operation experienced by a portable device;
an electromagnetic field sensor circuit configured to detect electromagnetic signals;
an electromagnetic signal emitter circuit configured to emit a particular electromagnetic signal; and
a processor, operably coupled to the memory, the electromagnetic field sensor circuit, and the electromagnetic signal emitter circuit, and configured to:
detect, via the electromagnetic field sensor circuit, a first electromagnetic signal, wherein the first electromagnetic signal originates from an external device;
determine a first set of attributes associated with the first electromagnetic signal, wherein the first set of attributes comprises a first power level, a first frequency range, and a first electromagnetic pattern associated with the first electromagnetic signal;
compare the first electromagnetic signal with the expected electromagnetic signal, wherein:
comparing the first electromagnetic signal with the expected electromagnetic signal comprises comparing at least one attribute from among the first set of attributes with a corresponding attribute associated with the expected electromagnetic signal; and
the corresponding attribute comprises a second power level, a second frequency range, or a second electromagnetic pattern;
determine, based at least in part upon the comparison, a difference between the first electromagnetic signal and the expected electromagnetic signal;
determine that the difference between the first electromagnetic signal and the expected electromagnetic signal is more than a threshold value; and
in response to determining that the difference between the first electromagnetic signal and the expected electromagnetic signal is more than the threshold value:
determine that the external device is a malicious device attempting to access information associated with the portable device; and
perform one or more countermeasure actions, wherein the one or more countermeasure actions comprise an emission of the particular electromagnetic signal via the electromagnetic signal emitter circuit, wherein the particular electromagnetic signal is configured to counter an electromagnetic field generated by the external device.

2. The system of claim 1, wherein:
the system further comprises a magnetic field modulation device configured to change a modulation of a magnetic stripe associated with the portable device;
the magnetic field modulation device comprises a magnetic coil;
the one or more countermeasure actions further comprise changing the modulation of the magnetic stripe, wherein changing the modulation of the magnetic stripe changes one or more characteristics associated with the magnetic stripe; and
the one or more characteristics comprise at least one of a magnetic signal frequency, a magnetic signal amplitude, or a bit stream associated with the magnetic stripe.

3. The system of claim 1, wherein:
the system further comprises a retractable shielding device configured to enclose at least a portion of a surface of the portable device; and
the one or more countermeasure actions comprise activating the retractable shielding device to enclose at least the portion of the surface of the portable device.

4. The system of claim 1, wherein:
the system further comprises an adhesive projecting device configured to project an adhesive substance; and
the one or more countermeasure actions further comprise projecting the adhesive substance.

5. The system of claim 1, wherein the processor is further configured to communicate an alert message that indicates the external device is detected and the one or more countermeasure actions are performed.

6. The system of claim 1, wherein the processor is further configured to:
detect a location of the external device with respect to the portable device based at least in part upon the first electromagnetic signal; and
communicate an instruction message to one or more components associated with the portable device, wherein the instruction message comprises the location of the external device and an instruction to perform the one or more countermeasure actions.

7. The system of claim 1, wherein the one or more countermeasure actions further comprise encrypting transmission signals with an encryption key, wherein the encrypted transmission signals are associated with an interaction with another device.

8. A method comprising:
detecting, via an electromagnetic field sensor circuit, a first electromagnetic signal, wherein the first electromagnetic signal originates from an external device;
determining a first set of attributes associated with the first electromagnetic signal, wherein the first set of attributes comprises a first power level, a first frequency range, and a first electromagnetic pattern associated with the first electromagnetic signal;
comparing the first electromagnetic signal with an expected electromagnetic signal, wherein:
comparing the first electromagnetic signal with the expected electromagnetic signal comprises comparing at least one attribute from among the first set of attributes with a corresponding attribute associated with the expected electromagnetic signal; and
the corresponding attribute comprises a second power level, a second frequency range, or a second electromagnetic pattern;
determining, based at least in part upon the comparison, a difference between the first electromagnetic signal and the expected electromagnetic signal;
determining that the difference between the first electromagnetic signal and the expected electromagnetic signal is more than a threshold value; and
in response to determining that the difference between the first electromagnetic signal and the expected electromagnetic signal is more than the threshold value:
determining that the external device is a malicious device attempting to access information associated with a portable device; and
performing one or more countermeasure actions, wherein the one or more countermeasure actions comprise an emission of a particular electromagnetic signal via an electromagnetic signal emitter circuit, wherein the particular electromagnetic signal is configured to counter an electromagnetic field generated by the external device.

9. The method of claim 8, wherein:
the one or more countermeasure actions further comprise changing a modulation of a magnetic stripe associated with the portable device, wherein changing the modulation of the magnetic stripe changes one or more characteristics associated with the magnetic stripe; and
the one or more characteristics comprise at least one of a magnetic signal frequency, a magnetic signal amplitude, or a bit stream associated with the magnetic stripe.

10. The method of claim 8, wherein:
the one or more countermeasure actions comprise activating a retractable shielding device to enclose at least a portion of a surface of the portable device.

11. The method of claim 8, wherein the one or more countermeasure actions further comprise projecting an adhesive substance.

12. The method of claim 8, further comprising communicating an alert message that indicates the external device is detected and the one or more countermeasure actions are performed.

13. The method of claim 8, further comprising:
detecting a location of the external device with respect to the portable device based at least in part upon the first electromagnetic signal; and
communicating an instruction message to one or more components associated with the portable device, wherein the instruction message comprises the location of the external device and an instruction to perform the one or more countermeasure actions.

14. The method of claim 8, wherein the one or more countermeasure actions further comprise encrypting transmission signals with an encryption key, wherein the encrypted transmission signals are associated with an interaction with another device.

15. A non-transitory computer-readable medium storing instructions that when executed by a processor, cause the processor to:
detect, via an electromagnetic field sensor circuit, a first electromagnetic signal, wherein the first electromagnetic signal originates from an external device;
determine a first set of attributes associated with the first electromagnetic signal, wherein the first set of attributes comprises a first power level, a first frequency range, and a first electromagnetic pattern associated with the first electromagnetic signal;
compare the first electromagnetic signal with an expected electromagnetic signal, wherein:
comparing the first electromagnetic signal with the expected electromagnetic signal comprises comparing at least one attribute from among the first set of attributes with a corresponding attribute associated with the expected electromagnetic signal; and
the corresponding attribute comprises a second power level, a second frequency range, or a second electromagnetic pattern;
determine, based at least in part upon the comparison, a difference between the first electromagnetic signal and the expected electromagnetic signal;
determine that the difference between the first electromagnetic signal and the expected electromagnetic signal is more than a threshold value; and
in response to determining that the difference between the first electromagnetic signal and the expected electromagnetic signal is more than the threshold value:
determine that the external device is a malicious device attempting to access information associated with a portable device; and
perform one or more countermeasure actions, wherein the one or more countermeasure actions comprise an emission of a particular electromagnetic signal via an electromagnetic signal emitter circuit, wherein the particular electromagnetic signal is configured to counter an electromagnetic field generated by the external device.

16. The non-transitory computer-readable medium of claim 15, wherein:
the one or more countermeasure actions further comprise changing a modulation of a magnetic stripe associated with the portable device, wherein changing the modulation of the magnetic stripe changes one or more characteristics associated with the magnetic stripe; and
the one or more characteristics comprise at least one of a magnetic signal frequency, a magnetic signal amplitude, or a bit stream associated with the magnetic stripe.

17. The non-transitory computer-readable medium of claim 15, wherein:
the one or more countermeasure actions comprise activating a retractable shielding device to enclose at least a portion of a surface of the portable device.

18. The non-transitory computer-readable medium of claim 15, wherein the one or more countermeasure actions further comprise projecting an adhesive substance.

19. The non-transitory computer-readable medium of claim 15, wherein the instructions further cause the processor to communicate an alert message that indicates the external device is detected and the one or more countermeasure actions are performed.

20. The non-transitory computer-readable medium of claim 15, wherein the instructions further cause the processor to:
detect a location of the external device with respect to the portable device based at least in part upon the first electromagnetic signal; and
communicate an instruction message to one or more components associated with the portable device, wherein the instruction message comprises the location of the external device and an instruction to perform the one or more countermeasure actions.
